(19) United States
(12) Patent Application Publication
(10) Pub. No.: US 2007/0234107 A1
(43) Pub. Date: Oct. 4, 2007

(54) Dynamic storage data protection

(75) Inventor: James M. Davison, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines Corporation, Armonk, NY (US)

(21) Appl. No.: 11/394,847

(22) Filed: Mar. 31, 2006

(51) Int. Cl. G06F 11/00

(52) U.S. Cl. 714/6

(57) ABSTRACT

A method, system and computer program product are provided for increasing the level of protection for data in a redundant storage system. A non-catastrophic error in a component in a redundant storage system is detected. Then, data exposed by the non-catastrophic error is identified and unallocated space in a storage device which is not exposed to the non-catastrophic error is reserved. The exposed data is then migrated from its original storage space to the reserved storage space. Even though it may take a number of hours for recovery of the system to be completed, data is less exposed to the risk of a second failure occurring before the first can be repaired.

### TECHNICAL FIELD

The present invention relates generally to storage systems and, in particular, to increasing the level of protection for data stored in redundant storage systems such as RAID arrays.

### BACKGROUND ART

Redundant-component storage systems, including RAID arrays, are becoming more powerful and reliable as well as more popular. Similarly, the hard drives within the arrays are becoming more reliable as well as larger in terms of capacity. Consequently, data stored in such systems has become more secure, especially with newer redundant hardware and software configurations (for example, arrays across loops and PPRC (“peer-to-peer remote copy”)). Nonetheless, RAID arrays have a failure rate which, though small, is non-zero. Given the large number of installed arrays, and the number of components in each, the risk of a failure can be significant. Redundant storage systems can be designed to survive the failure of a component, and remain in operation while the component is repaired. Thus, if a system loses a critical component, the system may remain in operation while the faulty component is repaired or replaced. However, it may take several hours or more to restore the system to full redundant operation, even assuming that the failure isolation was successful as isolation can require significant time unrelated to repair of the failure. In the meantime, the system is at risk of a second failure. Neither the first nor the second failures may be catastrophic in isolation; however, a second failure before the first is corrected may indeed be catastrophic and cause loss of access to data or actual loss of data. That is, while a redundant system is configured to allow recovery from the loss or failure of a single component, it may not be able to recover from a dual-failure or loss. Such an event, though exceedingly rare, may cost a large company millions of dollars until the system can be brought back on line. In fact, given the cost per unit time to perform a repair, the company will lose money until the system is brought back online, with potentially unlimited losses being possible.

Consequently, a need remains for a higher level of protection for data in the event of a double component loss in a redundant storage system.

### SUMMARY OF THE INVENTION

The present invention provides a method and a computer program product for increasing the level of protection for data in a redundant storage system. A non-catastrophic error in a component in a redundant storage system is detected. Then, data exposed by the non-catastrophic error is identified and unallocated space in a storage device which is not exposed to the non-catastrophic error is reserved. The exposed data is then migrated from its original storage space to the newly reserved storage space. Even though it may take a number of hours for recovery of the system to be completed, data is quickly protected from the risk of a second failure and less exposed to the risk of a second failure occurring before the first can be repaired.

The present invention further provides a redundant storage system including first and second arrays, each comprising a plurality of storage devices, such as hard disk drives, at least two switches and device adapters. For redundancy, each switch is coupled to each storage device and to two device adapters. The system further includes a processor operable to detect a non-catastrophic error in a component of the redundant storage system, identify data exposed by the non-catastrophic error, reserve unallocated space in a storage device which is not exposed to the non-catastrophic error, and migrate the exposed data from its original storage space to the reserved storage space. Thus, data is less exposed to the risk of a second failure occurring before the first can be repaired.

### BRIEF DESCRIPTION OF THE DRAWINGS

FIG. 1 is a block diagram of a RAID storage system in which one drive has failed putting the system at risk in the event of a failure in another drive;

FIG. 2 is a block diagram of a RAID storage system in which an upper level component has failed putting the system at risk in the event of a failure in another upper level component;

FIG. 3 is a block diagram of a RAID storage system in which one interface card has failed putting the system at risk in the event of a failure in another interface card;

FIG. 4 is a block diagram of a storage system in accordance with the present invention;

FIG. 5 is a flow chart of a method in accordance with the present invention; and

FIG. 6 is a block diagram of a RAID storage system in which the present invention has been activated to reduce the risk of data or access loss following the failure of one component.

### DETAILED DESCRIPTION OF THE PREFERRED EMBODIMENT

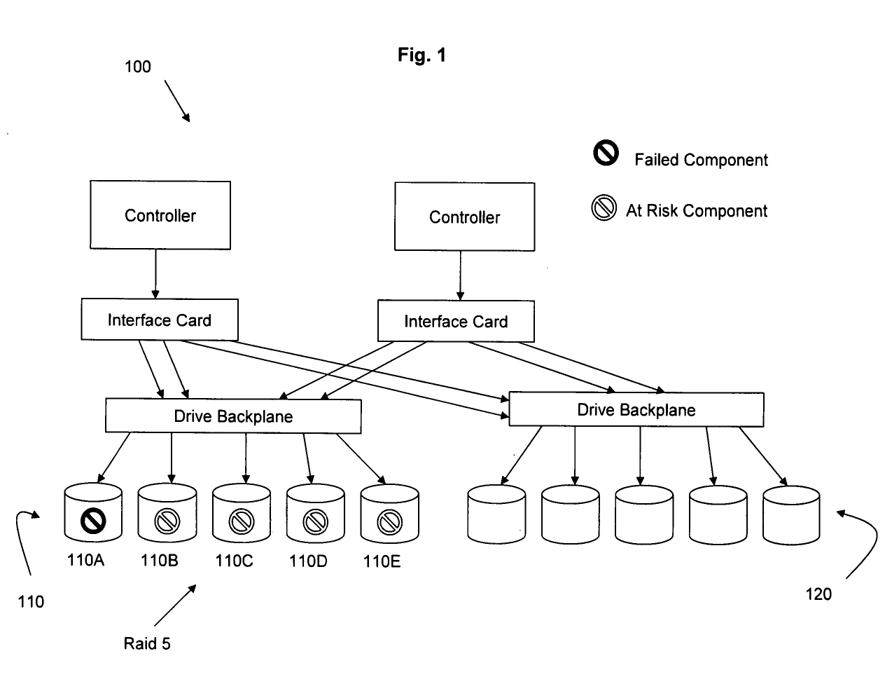

FIG. 1 is representative of a RAID storage system 100, such as RAID 5, in which one drive 110A in one of the drive arrays 110 has failed. Although data stored in the array 110 may continue to be accessed from the remaining drives 110B-110E, until the failed drive 110A is replaced, the system is vulnerable to a failure in a second drive in the array 110. While the loss of a single drive may not cause loss of access or of data, the loss of two drives in the same array will cause data loss when using some RAID algorithms.

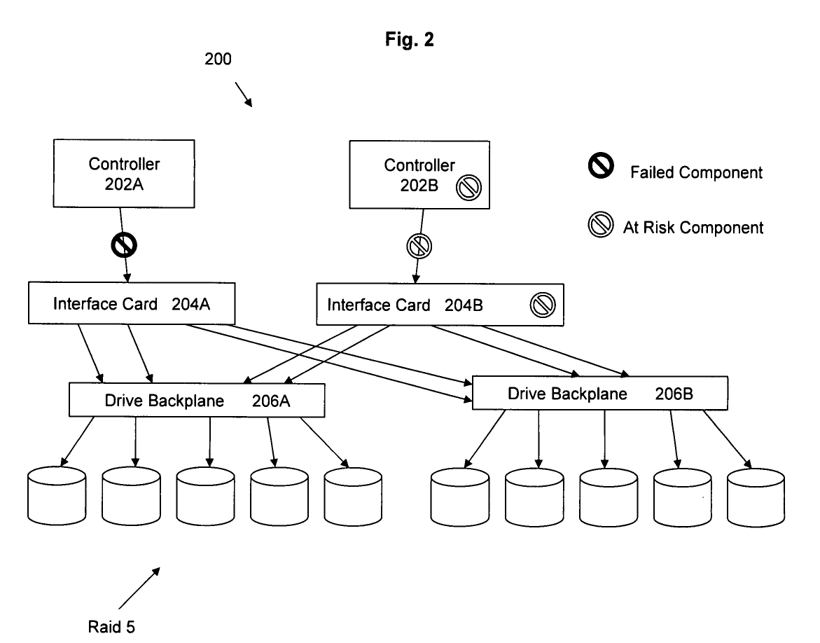

FIG. 2 is representative of another configuration of a RAID storage system 200 in which an upper level component has failed. An upper level component may include, for example, a controller 202A or 202B, an interface card 204A or 204B or a communication path from, for example, a controller 202A or 202B to an associated interface card 204A or 204B, respectively. As in the configuration illustrated in FIG. 1, the failure of a single upper level component may not cause a catastrophic failure in the system 200, because redundant paths are present between the second interface card 204B to the drive backplane 206A associated with the failed component. However, the system 200 remains vulnerable to a failure of a second upper level component.

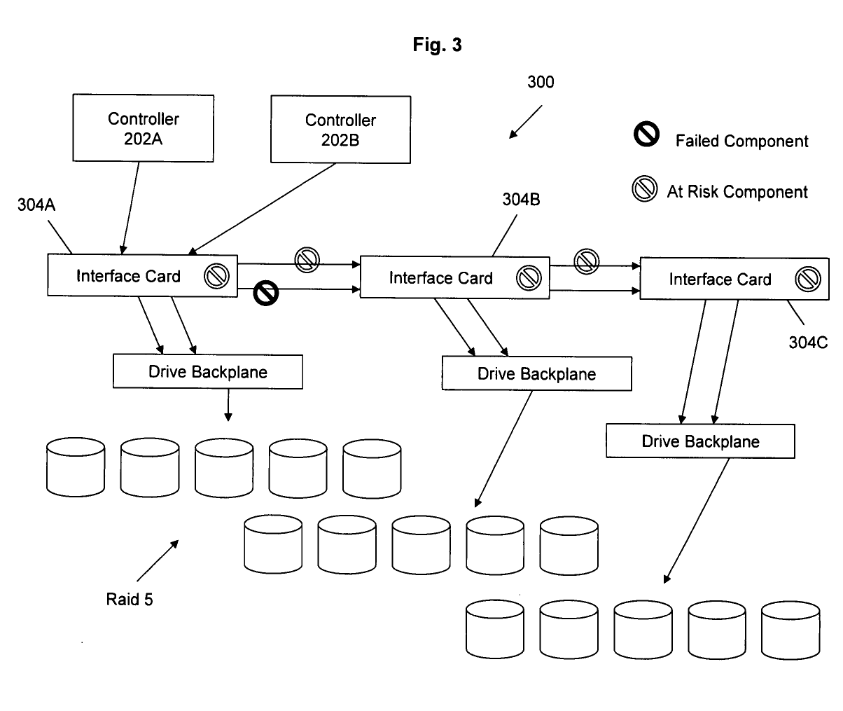

FIG. 3 is representative of still another configuration of a RAID storage system 300 in which interface cards 304A, 304B, 304C are coupled to redundant controllers 202A, 202B in a daisy-chain fashion. In the event that one of a redundant pair of paths between two interface cards, such as between the first and second interface cards 304A, 304B, fails, the system 300 may still operate by relying on the second of the redundant paths. However, as illustrated in FIG. 3, until the path is repaired, the system is vulnerable to a failure of any of the interface cards 304A, 304B, 304C or of any of the other paths in the chain.

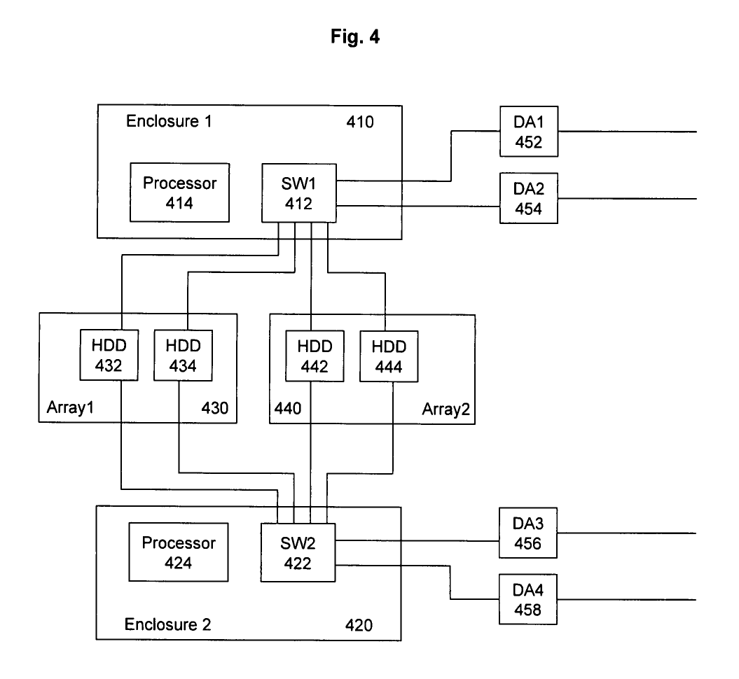

FIG. 4 is a block diagram of a storage system 400 in accordance with the present invention. The system 400 includes two enclosures 410, 420, each including at least one switch 412, 422, respectively, and a programmable enclosure processor 414, 424, respectively. The system 400 further includes a plurality of RAID arrays, represented in FIG. 4 by the arrays 430, 440. Although the system 400 may include more than two arrays, for clarity only two are illustrated. Each array includes a plurality of dual-ported hard disk drives (HDDs), represented in FIG. 4 by the HDDs 432, 434 and 442, 444, respectively. Although the arrays 430, 440 may include more than two drives each, for clarity only two are illustrated. The system 400 also includes a plurality of device adapters (DAs) 452, 454, 456, 458 to which are attached one or more hosts (not shown).

The first and third device adapters 452, 456 are redundantly coupled to the first switch 412; the second and fourth device adapters 454, 458 are redundantly coupled to the second switch 422. Each switch 412, 422 is coupled to one of the two ports of each HDD 432, 434, 442, 444. Consequently, in addition to the inherent security provided by RAID arrays, full redundancy of other components is also provided.

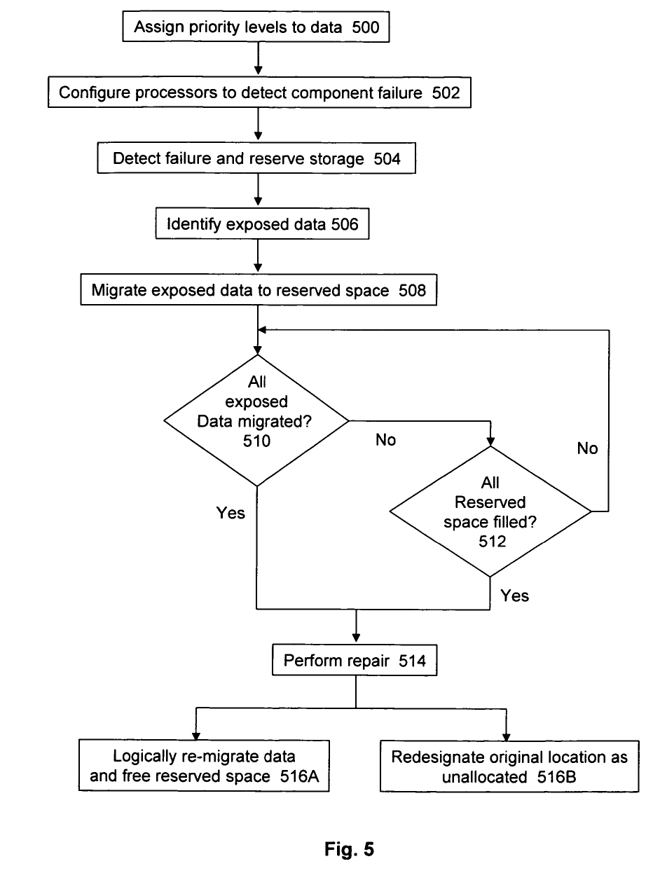

The processors 414, 424 are configured to keep track of where data resides and how much storage space is unallocated. Referring also to the flowchart of FIG. 5, a system user may assign a priority level to data or types of data (step 500). For example, a database index, without which database records cannot be accessed, may be assigned the highest priority while data being prepared for archiving, data not required for business operations and data accessed infrequently may be assigned a lower priority. Other examples of high priority data may include critical customer records, high security data, small/frequently accessed data sets, any data whose value to the customer is worth this level of protection and any data that must be accessed with 100% availability under all circumstances—911 phone records, military applications, retail order processing and the like. In operation, one or both processors 414, 424 are configured to detect the failure of a component in the system 400 (step 502). Upon such detection, a processor 414, 424 reserves, or blocks off from other usage, unallocated storage space (step 504). Then, a processor 414, 424 identifies data that would be lost or whose access would be lost in the event of the failure of a second component (hereinafter, “exposed” data) (step 506). A processor 414, 424 then directs that exposed data be logically copied (migrated) to the reserved space (step 508), preferably leaving the original, exposed version in place. Also preferably, exposed data is migrated in order of assigned priority until all of the exposed data has been migrated (step 510) or, more likely, until all of the reserved space has been filled (step 512). For example, data stored in the first array 430 may be migrated to the second array 440 and data stored in the second array 440 may be migrated to the first array 430. One or both of of the processors 114, 124 maintains a record of the location of the migrated data in the reserved area as well as the location of the original data in order to maintain access to the data until the recovery is completed.

Repair or replacement of the faulty component may now be performed (step 514) and the system 400 brought back to full, redundant operation. Even though it may take a number of hours to complete the recovery, data is no longer exposed to the risk of a second failure occurring before the first can be repaired. After the component has been repaired, a decision is made, based on an algorithm which takes into account data safety and/or convenience, to determine whether to restore the migrated data in its original, formerly at risk location or to maintain it in its migrated location (step 516). If the former, the migrated data is logically re-migrated back to the original location by resuming access to the previously exposed data (step 518). The reserved area may then be freed and returned to the unallocated storage pool (step 520). If the latter, the migrated data remains in the new (previously reserved) space while the original location may be re-designated as unallocated (step 522) and available for normal storage or to receive migrated data in the event of another, later failure.

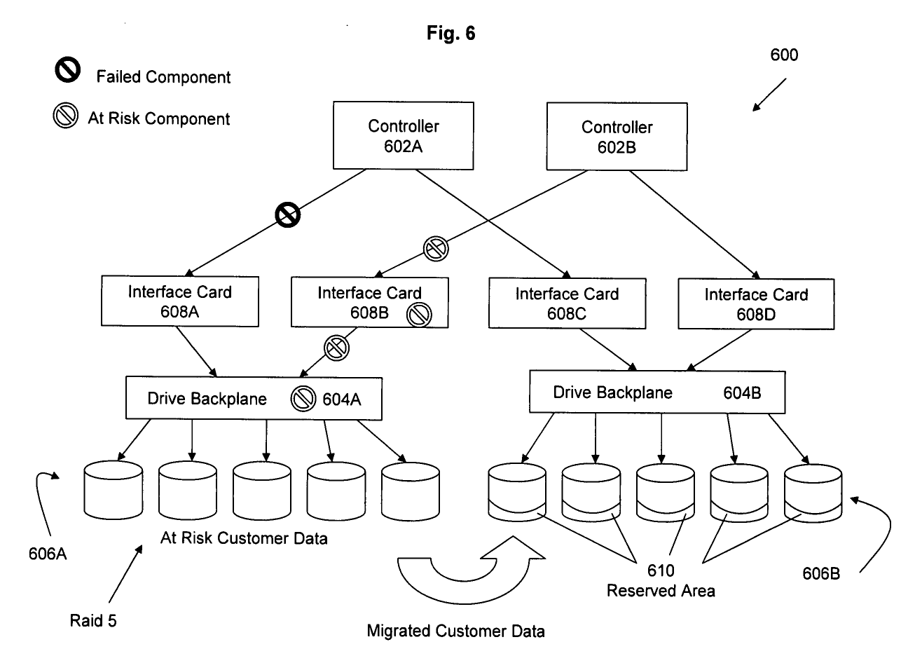

FIG. 6 is representative of another configuration of a RAID storage system 600 in which the present invention has been implemented. The system 600 includes redundant controllers 602A, 602B, two drive backplanes 604A, 604B serving two RAID arrays 606A, 606B. A first set of redundant interface cards 608A, 608B are each coupled to the first drive backplane 606A while a second set of redundant interface cards 608C, 608D are each coupled to the second drive backplane 606B. Both controllers 602A, 602B are coupled to one of each set of the redundant interface cards. In the illustration, the path between the first controller 602A and the first interface card 608A has failed (a failure of the first interface card 608A would produce the same results). Because of the redundancy of the system 600, data in the first array 606A may still be accessed through the second controller 602B and second interface card 608B. However, as indicated, the data stored in the first array 606A is now vulnerable to a failure of the second controller 602B, the second interface card 608B, the first drive backplane 604A or any of the connecting paths (collectively “at risk components”). By implementing the present invention, upon failure of the first component, space 610 in the second array 606B is reserved and selected priority data migrated from the first array 606A to the reserved area 610 of the second array 606B. Thus, if one of the at risk components fails, the migrated data from the first array 606A is still accessible in the reserved area 610 of the second array 606B. While the system 600 may still be vulnerable to failures of other components, the present invention may significantly reduce the risk of a loss of critical data or access to such data.

Not all faults or failures will trigger a data migration. Examples include faults that don't expose data to a secondary failure, such as software faults, non-critical redundant hardware failures, such as the failure of a host connection port or host connection adapter.

The present invention allows the storage system to initiate action in response to a failure, without the intervention of an operator. The time required to perform a repair consists of several components: isolating the failed component, alerting an operator of failure, replacing the component and restoring the system to service. In the absence of the present invention, a failure during any of the steps may result in an extended exposure to a secondary failure and may, in fact, increase the severity of the failure. However, the present invention provides an extra measure of protection from failures during any of these steps, thereby increasing the reliability of the storage system and the integrity of the customer's data.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for increasing the level of protection for data in a redundant storage system.

What is claimed is:

1. A method for increasing the level of protection for data in a redundant storage system, comprising:
detecting a non-catastrophic error in a component in a redundant storage system;
identifying data exposed by the non-catastrophic error;
reserving unallocated space in a storage device which is not exposed to the non-catastrophic error; and
migrating the exposed data from its original storage space to the reserved storage space.

2. The method of claim 1, further comprising:
assigning a priority to data stored in the redundant storage system; and
migrating the exposed data to the reserved storage space in order of the priority assigned to the exposed data.

3. The method of claim 1, further comprising:
detecting a correction of the non-catastrophic error;
re-migrating the exposed data to its original storage space;
releasing the reserved space to unallocated space; and
directing host access requests to the previously exposed data stored in the original storage space.

4. The method of claim 1, further comprising:
detecting a correction of the non-catastrophic error;
designating the original storage space as unallocated space; and
directing host access requests to the previously exposed data stored in the reserved storage space.

5. The method of claim 1, wherein the storage system includes first and second storage arrays and migrating the exposed data comprises:
migrating exposed data from the first storage array to the second storage array; and
migrating exposed data from the second storage array to the first storage array.

6. A redundant storage system, comprising:
first and second arrays, each comprising a plurality of storage devices;
first and second storage switches, each switch coupled with each storage device;
first and second device adapters, each coupled to the first storage switch;
third and fourth device adapters, each coupled to the second storage switch; and
a processor operable to:
detect a non-catastrophic error in a component of the redundant storage system;
identify data exposed by the non-catastrophic error;
reserve unallocated space in a storage device which is not exposed to the non-catastrophic error; and
migrate the exposed data from its original storage space to the reserved storage space.

7. The redundant storage system of claim 6, wherein the processor is further operable to migrate the exposed data to the reserved storage space in order of a priority assigned to the exposed data.

8. The redundant storage system of claim 6, wherein the processor is further operable to:
detect a correction of the non-catastrophic error;
re-migrate the exposed data to its original storage space;
release the reserved space to unallocated space; and
direct host access requests to the previously exposed data stored in the original storage space.

9. The redundant storage system of claim 6, wherein the processor is further operable to:
detect a correction of the non-catastrophic error;
designate the original storage space as unallocated space and
direct host access requests to the previously exposed data stored in the reserved storage space.

10. The redundant storage system of claim 6, wherein to migrate the exposed data, the processor is further operable to:
migrate exposed data from the first storage array to the second storage array; and
migrate exposed data from the second storage array to the first storage array.

11. A computer program product of a computer readable medium usable with a programmable computer, the computer program product having computer-readable code embodied therein for increasing the level of protection for data in a redundant storage system, the computer-readable code comprising instructions for:
detecting a non-catastrophic error in a component in a redundant storage system;
identifying data exposed by the non-catastrophic error;
reserving unallocated space in a storage device which is not exposed to the non-catastrophic error; and
migrating the exposed data from its original storage space to the reserved storage space.

12. The computer program product of claim 11, wherein the computer-readable code further comprises instructions for:
assigning a priority to data stored in the redundant storage system; and
migrating the exposed data to the reserved storage space in order of the priority assigned to the exposed data.

13. The computer program product of claim 11, wherein the computer-readable code further comprises instructions for:
detecting a correction of the non-catastrophic error;
re-migrating the exposed data to its original storage space;
releasing the reserved space to unallocated space; and
directing host access requests to the previously exposed data stored in the original storage space.

14. The computer program product of claim 11, wherein the computer-readable code further comprises instructions for:
detecting a correction of the non-catastrophic error;
designating the original storage space as unallocated space; and
directing host access requests to the previously exposed data stored in the reserved storage space.

15. The computer program product of claim 11, wherein the storage system includes first and second storage arrays and the instructions for migrating the exposed data comprise instructions for:
migrating exposed data from the first storage array to the second storage array; and
migrating exposed data from the second storage array to the first storage array.
